(19) United States
(12) Patent Application Publication
(10) Pub. No.: US 2020/0342189 A1
(43) Pub. Date: Oct. 29, 2020

(54) Method of Receiving RFID Signals from Multiple Transponders

(71) Applicant: Vium, Inc., San Mateo, CA (US)

(72) Inventors: Jonathan Betts-Lacroix, Belmont, CA (US); Eyal Aklimi, San Francisco, CA (US)

(73) Assignee: Vium, Inc., San Mateo, CA (US)

(21) Appl. No.: 16/396,662

(22) Filed: Apr. 27, 2019

(51) Int. Cl. G06K 7/10; A01K 29/00; A01K 1/03

(52) U.S. Cl. CPC G06K 7/10366; A01K 1/031; A01K 29/005; G06K 7/10336

(57) ABSTRACT

A device and method of receiving RFID signals are described using a grid of transceivers driven to generate RF phase synchronous transmissions of RFID query messages, while each transceiver in the grid receives replies from individual RFIDs independently. The transceivers may be located in a planar array at the floor of an animal cage, while the RFIDs are implanted in animals in the cage. Additional transceivers may be located at the sides of the cage. Locations of individual animals in the cage are determined using a corresponding map of the locations of the transceivers.

### BACKGROUND OF THE INVENTION

Prior art methods of locating animals in a cage include implanting an radio frequency identification device (RFID), a transponder, in an animal, then using a transceiver to query the RFID, then receiving back a transponder signal from the transponder to the transceiver. The transponder signal typically comprises a unique device identifier and may include other information such as a temperature of an animal. The RF communication distance between the transponder and the transceiver is typically a short distance, such as a few inches. If an animal is in range of the transceiver, it is “detected.” If an animal is not in range then it is, “not detected.” A weakness of this system is it provides only information when an animal is in RF proximity to the transceiver.

Other prior art uses multiple transceivers, in order to provide information when an animal is in one of the proximal locations to the multiple transceivers. A weakness of this system is that the transceiver signals may interfere with each other, and thus must be spaced widely. This spacing leaves gaps in the coverage area.

Commercial prior art transceivers have integrated transmit and receive logic. They do not communicate with each other and thus cannot transmit simultaneously.

Prior art includes Standards ISO 11785-1996 and ISO 18000. It also includes U.S. Pat. No. 7,049,933 and Chinese Patent No. CN103116734.

### SUMMARY OF THE INVENTION

Embodiments of this invention overcome the weaknesses of prior art. An array of transceivers is used to detect transponders in animals. To avoid interference between the transceivers, they all transmit simultaneously. These transmissions are known as “queries” to any transponders within radio frequency (RF) range. The transmit power of the transponders is much weaker than the transmit power of the transceivers. Some transponders have no transmit power at all, as they change a “visible” characteristic, such as an RF resonance. However, we still speak of a transponder as “sending” a signal comprising data. Only a transponder that is close to a transceiver will properly receive its signal. A map associating physical locations of the transceivers with portions or locations within a cage then provides a location of an animal in the cage with the responding transponder. Spacing of the transceivers is important. A planar grid of transceivers may be under or over a cage. In additional transceivers may be placed on the sides of the cage, near to exercise, sleeping, eating or drinking apparatuses. These transceivers will pick up an animal location when the animal is using one of these apparatuses. Such apparatuses may be raised above a cage floor such that they are effectively out of near-field RF range of transceivers located under the cage floor.

It is important that all transceivers transmit signals simultaneously. Such signals may comprise data, such as a “query,” or may comprise a continuous RF carrier. In this way they do not interfere with each other, but rather create a uniform RF query field in the cage. Transponders each respond timely to a query, or reply periodically to an RF carrier. However, they do not respond synchronously; rather each transponder provides its own data timely, but not synchronized. Each transceiver needs separate, independent receive logic.

### BRIEF DESCRIPTION OF THE DRAWINGS

FIG. 1 shows an exemplary cage with two mice and a grid of transceivers.

FIG. 2 shows an embodiment of timing diagram of transmission and reception of RF signals.

FIG. 3 shows a block diagram of transmit and receive logic for transceivers.

FIG. 4 shows exemplary modulation and reception of two transponders and two transceivers.

FIG. 5 shows an exemplary circuit for an embodiment.

### DETAILED DESCRIPTION

Scenarios, descriptions, drawings and options are non-limiting embodiments.

As explained above, a nexus of embodiments is having a group of transceivers broadcast synchronously, while each transceiver separately receives data from individual transponders. In one embodiment a “query” signal is broadcast, then transceivers listen. In another embodiment, transceivers phase-synchronously broadcast a continuous carrier signal, while each transceiver listens independently for changes in signal amplitude caused by a nearby transducer.

### RF Signaling

For some types of standardized RFIDs and embodiments, communication works as follows. A transmitter, called a transceiver, broadcasts an unmodulated RF signal, reasonably called a carrier. The carrier may be broadcast continuously or intermittently. The transceiver contains a circuit resonant at the RF carrier frequency. The circuit typically includes a coil with an inductance and a capacitor. This combination is sometimes called a, “tank.” As the tank resonates at the carrier frequency the coil acts as a broadcast antenna creating a “near-field.”

RFIDs, in this near-field, called transponders, also have a resonant tank circuit at the carrier frequency. Because the distance between the transceiver and transponder is short compared to the wavelength of the carrier, both the transceiver tank and the transponder tank share the same near-field electromagnetic radiation: they resonate together. Typically, the transponders receive the broadcast carrier, rectify it, and use that as an internal power source. The transponder electronics have the ability to short out or otherwise modify the resonance of its tank. When so shorted, the total amplitude of the carrier signal within the near-field weakens. This weakened field strength may be detected at the transceiver, typically as slightly lower voltage amplitude at the tank. In this way, the transponders are able to effectively send data to the transceivers, by alternatively turning on and off its tank shorting circuit, in some time pattern.

For one transceiver and one transponder in the same near-field, this system works well enough. It is a simple matter to detect if a transponder is in proximity, that is, in the same near-field as the transceiver, because the transceiver then detects some data from the transponder. However, receiving signals, or detecting the presence of multiple transponders in the same near-field is challenging because the transponders interfere with each other. Placing multiple transceivers in a physical arrangement, such as a grid, to detect multiple transponders, is challenging because the multiple transceivers also share a near-field and thus also interfere with each other.

A solution of one embodiment is to use an array of multiple transceivers operating synchronously to create a single, shared near-field. The effect of any transponder in the near-field is quite small, and is most detectable close to its nearest transponder.

The spacing of the transceivers is important. If they are too far apart, then special resolution is lost. For example, if there are four transceivers under a cage floor, there is an effective distance resolution to one quarter of the cage. If there are 40 transceivers under a cage floor, there is potentially an effective resolution of forty areas within the cage. However, if the transceivers are too close together, a single transponder will affect the signal strength at the two adjacent transceivers approximately equally, and they will not be able to distinguish one location of the transponder from another. Additionally, the broadcast signal strength at each transceiver will swamp the small change in signal strength at an adjacent transceiver, making neither able to detect a signal strength change caused by a nearby transponder. Therefore, spacing of transceivers must be carefully chosen to balance these factors.

In a simple model, the transceivers should be spaced as close together as possible (to maximize special resolution) while still being able to detect transponders. This distance could be determined experimentally for any particular set of devices, in an appropriate environment. Note that a, “received signal strength” is really a detection of signal amplitude change at a transceiver due to the presence or absence of a non-shorted transponder tank. This might be on the order of a few tens of millivolts on a signal of 100 volts, as measured at the transceiver tank. “Noise,” in this environment, is variation in the signal strength at the transceiver tank from all other sources. The minimum spacing of two transceivers is such that each is able to reliably receive data from a transponder at a selected target distance. “Reliable,” in this context, may be a predetermined signal-to-noise ratio or a percent of validly received transponder messages. For transceivers in a two-dimensional grid, the definitions and requirements are similar. A “target distance” may be a typical distance from a transponder to a transceiver. For example, if an array of transceivers is under a cage floor, and transponders are implanted between the shoulders of rodents in the cage, a target distance may be the typical or average vertical distance normal from the transceiver array plane to the transponders when the rodent is moving about the cage. References to a target distance, in some embodiments, also include any distance less than the target distance. A suitable reliable read rate might be 100 percent, or 100 percent minus specialized exceptions that do not diminish the value or use of the invention as a whole, or greater than 90 percent, or greater than 50 percent, as examples, as a rodent moves typically about its cage. A “read rate” and a “signal-to-noise” have a close relationship, and typically either one may be used to determine acceptable transceiver spacing, for a given environment and circuitry. With respect to claim construction and the rule of equivalents, they may be considered functionally equivalent. A successful read by an array of transceivers is when any transceiver in the array receives a valid transponder message. Note that such testing or measurements is typically done with only a single transponder, such as a single animal in a cage, as two transponders sufficiently close to each other may also cause a non-read. For two or more animals in a cage, typically the total valid read rate will therefore be less than the valid rate if there is only a single animal in the same cage.

A desired transceiver spacing is such that a read rate is at least a predetermined reliability at a selected target distance.

For cages with apparatuses, such as climbing structures, exercise wheels, and the like, design and interpretation is similar, suitably taking into account that spacing may now include also spacing inward, i.e., horizontally, from the sides of a cage.

Reply signals from RFID transponders are in response to the RF transmissions from transceivers.

### DETAILS IN FIGURES

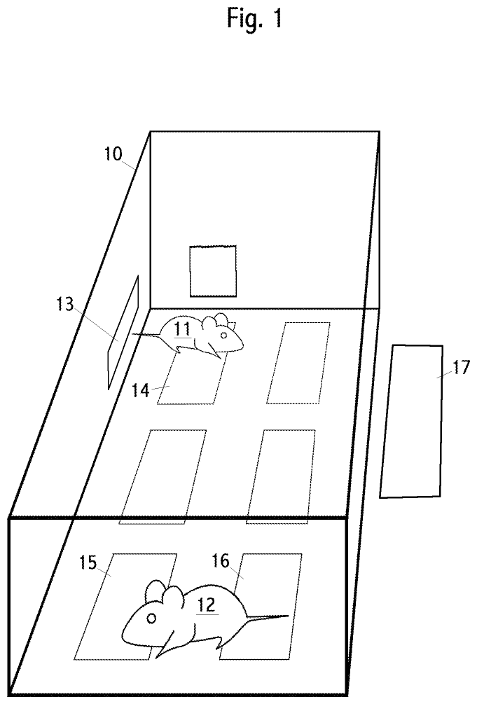

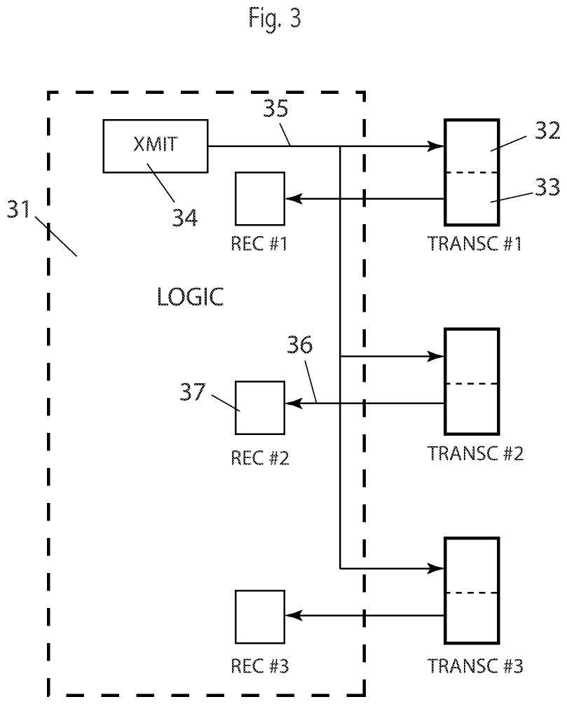

Turning first to FIG. 3, we see a schematic block diagram of this arrangement. Block 31, with a dotted outline, shows electronic logic. The Figure shows three exemplary transceivers, labeled TRANS #1-#3. The transceivers may be arranged in a grid under a cage floor, with optional additional transceivers located at the sides of the cage. See FIG. 1. The inside of the cage may be considered a “virtual box,” which defined by a volume effectively enclosed, as defined by RF fields, by the arrangement of the transceivers. Such a virtual box may be different than a physical cage; it may be smaller or larger. The logic 31 may be on a circuit board, with wiring to the transceivers. Transmit circuit 34 drives the transmit section of each transceiver in parallel, as shown by signal 35. By driving the transceivers perfectly in parallel, they transmit identical RF signals, simultaneously.

In FIG. 3, each transceiver is shown with two logical elements. The top half, such as 32, is for transmitting. The bottom half 33 is for receiving. Note however, the broadcast antenna in a transceiver, typically a coil of wire, may be the same antenna used for receive. Thus, the dotted line between 32 and 33 is more a logical line than a physical line separating physical components. In the same way, the signals 35 and 36 are logical, not physical. They may indicate only direction of signaling, for example, not discreet wires.

Continuing with FIG. 3, 37 shows one of three exemplary receive circuits, labeled REC #1-#3. Each receiver is logically connected to an individual transceiver, such as shown by one exemplary signal 36.

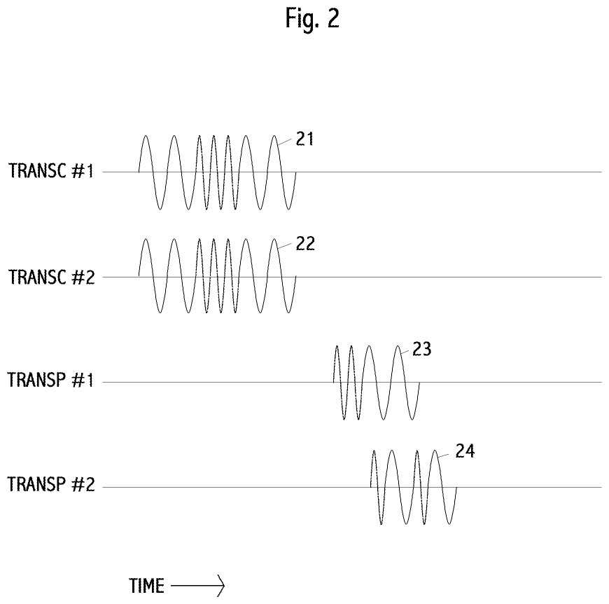

It is worth noting three logical levels of, “at the same time.” At the top level is, “logically at the same time,” which means on a human time scale of seconds, devices operate similarly. At the next, second, level, “signaling,” on a time scale of milliseconds, devices may be told to broadcast. For example, a control line to an integrated circuit (IC) may be to, “start transmitting.” Such a signal might be a binary control line or a command over a serial bus such as an ASCII RS-232 serial port, or an SDI or I2C bus. At the lowest, third, level, “RF modulation,” the RF carrier wave and its modulation are synchronous. All transceivers work effectively as a distributed antenna broadcasting the same RF signal. It is in this last mode that the transceivers are driven for broadcasts, that is, queries or requests. Thus, their RF signals do not interfere, but rather blanket a cage with a single RF signal, a “query” or “request,” needed to trigger a response from transponders. The signal 35 in FIG. 3 is at this third level. Typically, it carries a modulated RF signal, but the signal does not include the broadcast antennas in the multiple transceivers. Note that at most RF operating frequencies for RFID devices, the RF carrier wavelength is far longer than the size of an animal cage, particularly a cage for rodents, and so phase shift due to antenna spacing is not a problem. Transponders, however, reply timely at the top level as described in this paragraph. Each transceiver needs a separate receive circuit. See FIGS. 2, 3, 4 and 5. Transponders are less subject to interference from each other as their effective range of changing a near-field strength is less than the effective range of near-fields created by transceivers.

In the prior art, with integrated IC transceivers, only the top two levels discussed above, are available.

Turing to FIG. 1, we see a rodent cage 10 with two mice 11 and 12. On or under the cage floor is a planar array of six transceivers, with three marked as 14, 15 and 16. In addition, there are transceivers on the left side and back of the cage, with one labeled as 13. These side transceivers are oriented orthogonally to the base grid plane. Because a working distance between transceivers and transponders is short, relative to the size of the cage, the floor transponders may not be able to communicate with a transponder in an animal on exercise equipment or an a platform, such as may be used for weighing, food or water. For this reason, side transceivers, such as 13 are used, typically close to such exercise equipment and the like. Logic and other electronics for the transceivers may on a nearby circuit board 17. However, such electronics 17 may be located nearly anywhere in an enclosing building, and may be distributed. Although typically such electronics 17 are wired electrically to the transceivers, such electronics may communicate with other computers or electronics, such as for data acquisition or analysis, wirelessly, or via any other communications channel or network. Electronics 17 in FIG. 1 may include logic 31. Either 17 or 31 may be or may contain a “controller.” A controller may be inside or outside of the cage; it may be close or remote. The number of floor transceivers may range from three to 300. Another range is four to 24. The number of side transceivers, such as 13, may range from one to 48. Another range is two to six. Other embodiments use other arrangements or additional transceivers, such as another grid on a side, back, or top of the cage.

Each animal 11 and 12 typically has an implanted RFID transponder, not shown. Transponders may alternatively be placed on ear tags or collars. RFID transponders may also be used on (human) ankle bracelets. Each RFID has a unique identifier, which we call a serial number, which in turn allows animals to be uniquely identified.

Associated with the mechanical arrangement of the eight transceivers shown in the cage in FIG. 1 is a map. The purpose of the map is to identify physical locations of the animals in the cage corresponding to locations of transceivers. The map is not necessarily to scale, and does not necessarily cover the entire three-dimensional volume of the cage or the entire two-dimensional floor of the cage. For example, portions of a map may identify cage regions, such as exercise, climbing, feeding, sleeping and the like. Often, it is more valuable to know what an animal is doing in a cage rather than its exact location. Another parameter of interest in monitoring animals, particularly in an experimental vivarium, is activity. For this parameter, it is most useful to know time periods when an animal is active, such as moving around its cage, versus sleeping or resting. An output of logic 17 may be a log of specific animal locations, or readings from the transponders, or some local processing may be done, or data compression, to identify, or more closely identify, parameters of interest such as those discussed herein.

Based on information collected from embodiments, a physical action may be performed, such as removing an animal from a study, removing an animal from a cage, euthanizing an animal, or applying for a drug or treatment approval, such as a new drug application to the U.S. FDA. In addition, husbandry elements, other cage elements, or medical treatments may be changed. For example, different exercise equipment may be placed in a cage, or the type of food altered, or animal treatment protocols, such as drugs, altered.

Turning now to FIG. 2, we see schematics of timing diagrams for one embodiment using a “query” and “response” embodiment. Shown are drive signals and electromagnetic RF outputs 21 and 22 from two transceivers TRANSC #1 and TRANSC #2. These RF bursts are known as “queries” to any transponders within range. Also shown are two replies 23 and 24, responsive to the single query, 21 and 22, from two transponders, TRANSP #1 and TRANSP #2. Of importance, note that the signals 21 and 22 are perfectly in phase—both RF modulation and carrier are synchronous. Although modulation is shown as frequency modulation, a type of modulation typically used, the waveforms shown are purely schematic. Note that reply signals 23 and 24 are different from each other in two ways. First, they are not at the same time, even though both are in response to the same query. Second, they contain different data, including different RF IDs.

If TRANSP #1, 23, is associated with animal 11, and the transponder is 14, in FIG. 1, then the apparatus determines that animal 11 is located in the cage map responsive to the location of transceiver 14.

In some cases, no signal is received from any transponder. This may indicate that the associated animal is out of range of any transceivers. The embodiment may assume that the animal is nearby the last transceiver to detect a valid transponder reply from that animal. In some cases, two transceivers may detect the same reply. For example, transceivers 15 and 16 may detect the same signal from animal 12. In such a case, the animal 12 may be assumed to be located in between the two transceivers. Alternatively, the transceiver with the stronger signal may be the one used for location determination. Embodiments include signal strength detectors in the transceivers. Embodiments also include error detection and/or error correction in transponder signals. If no signal or an invalid signal is received by a transceiver, it may be because two animals are in close proximity to each other. The may be sleeping together, having sex, or fighting.

In some embodiments, data is bidirectional. For example, transceivers may send data to any or all transponders. Data may be directed to a specific transponder by using the transponder's ID in the message. Although we refer to transmissions from transceivers to transponders requests or queries, these signals may in fact include data to transponders. RFID transmissions may be identified by protocol terms of the art, such as half duplex, “HDX,” or full duplex, “FDX.” Embodiments use protocol details as described in ISO Standard ISO 11785-1996.

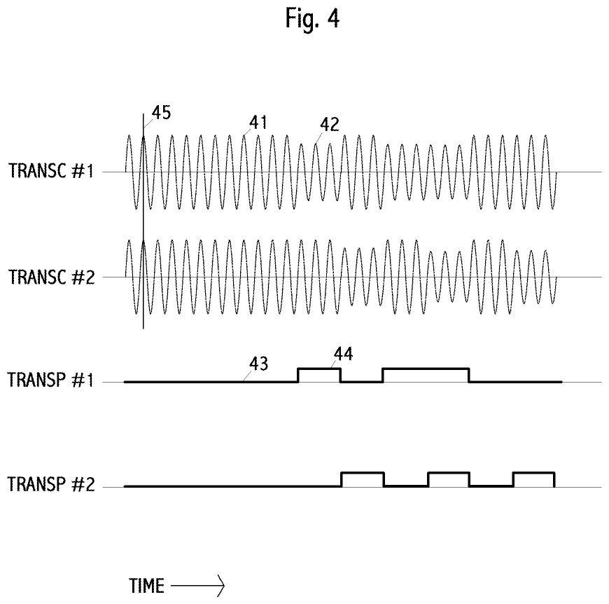

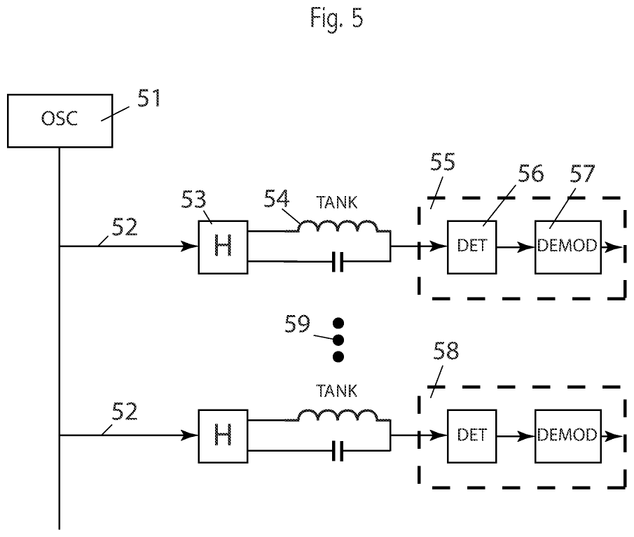

Note that some embodiments use a different system than shown in FIG. 2, such as a continuous carrier, as shown in FIGS. 4 and 5.

Turning now to FIG. 4, we see two simplified timelines of two transceivers and two transponders in a different embodiment than FIG. 2. The signals for TRANSC #1 (a first transceiver) and TRANSC #2 (a second transceiver) show a continuous carrier wave that is the same frequency and is phase synchronous, 45. This is typically implemented by using a single clock source, such as 34 in FIG. 3, which may be a square wave, sine wave, or other signal shape, at either a logic level or another analog signal level. This clock source goes to all drivers in all transceivers. Each transceiver needs a separate driver driving its own resonant circuit and antenna. Portion 41 shows a constant amplitude carrier with no signals received from a transducer, for both transceivers. Signals in the Figure for TRANSP #1 (a first transponder) and TRANSP #2 (a second transponder) show logically a portion of data for each transponder that it wishes to communicate. In practice, many more bits would be used, such as a unique transponder ID and optionally some other data, such as temperature, or other physiological parameters. Here, a low signal such as 43 is a binary zero and 44 is a binary one.

Continuing with FIG. 4, this Figure shows exemplary signals when TRANSP #1 is close to TRANSC #1, such that it changes the amplitude of a near-field at both antennas; while TRANSP #2 is close to TRANSC #2, so that it changes the amplitude of another near-field for this pair of devices. At time 43, TRANSP #1 is not transmitting. This logic level is also used during transmission to show a binary value such as zero. At time 44, TRANSP #1 begins its transmission by shorting its antenna (or uses another method of changing a near-field signal strength), reducing slightly an amplitude as measured at the antenna or resonant circuit for TRANSC #1. This is visible at 42. As TRANSP #1 continues its modulation sequence, TRANSC #1 continues to detect the modulation in this way. Meanwhile, TRANSP #2 is sending another data pattern. Note that the data from TRANSP #2 is not synchronous with data from TRANSP #1—it neither starts at the same time nor comprises the same bit stream. However, the time periods for both transponders to respond overlap. If a single transceiver attempted to receive from both transponders at the same time, their data would overlap and be corrupted and unreadable. Valid reception of the data from TRANSP #2 is visible at TRANSC #2.

Turning now to FIG. 5, we see a simplified circuit for two transceivers. A single oscillator of clock is shown 51, which drives all transceivers 52. Elements 51 and 52 and other circuitry used in common by all transceivers may be referred to as a “common transmit circuit.” Other circuits may accomplish synchronous transmission by other means. Each transceiver has a resonant tank circuit 54 which includes a broadcast antenna, here shown using an inductor symbol. In this circuit the tank is driven by a traditional H-bridge circuit 53, although many other driver circuits may be used. An H-bridge typically includes four switches, such as transistors or FETs, driven diagonally at opposite phases, so as to create a peak-to-peak signal that is nominally twice the supply voltage at the bridge. However, typically, the resonance of the tank causes an actual signal amplitude (measured as voltage, current, power or field-strength) in excess of twice a supply voltage.

The signal amplitude at the antenna or resonant circuit 54 is passes first through a detector 56 and then a demodulator 57, and then on to other logic, such as a controller, data acquisition, or remote electronics, not shown. The combination of the detector 56, demodulator 57, and associated circuitry may be called a receiver or receive circuit 55. Other circuits may be used to detect signal amplitude. Signal amplitude between 54 and 55 is shown schematically in FIG. 4 as 41 and 42. Data output from the demodulator is shown schematically as 43 and 44 in FIG. 4, where the demodulator is successfully recreating the data sent by a nearby transducer sharing the same near-field. 58 shows a second, independent receiver for a second transceiver. Receive circuits 55 and 58 operate independently. Dots 59 indicate more than two transceivers, such as may be arranged in a two-dimensional grid, with optional additional transceivers typically located orthogonal to the grid transceivers, typically above the plane of the grid, in any combination. FIG. 5 shows some signals as differential and some signals as single-ended. However, embodiments may use either implementation. Other circuits that operate similarly to produce the same result are within the construction of claimed embodiments.

The terms, “RFID” and “transponder,” as used herein and in claims and drawings, are generally interchangeable, unless otherwise stated or clear from context. A “controller” comprises necessary logic, non-transitory data storage, computation, communication and analog circuitry to support or interface other elements or method steps in claims and descriptions. An array or grid of transceivers is construed broadly. Such an arrangement may neither have uniform spacing nor be arranged in a clear pattern. An orientation of coils in antennas in transceivers may produce a strange, non-uniform near-field strength tensor field. In addition, other objects, such as metal, may change the shape of a near-field. Therefore, exact positions of transceivers in a grid or array, planer or not, may vary in order to optimize an embodiment, design, implementation or use.

Ideal, Ideally, Optimum and Preferred—Use of the words, “ideal,” “ideally,” “optimum,” “optimum,” “should” and “preferred,” when used in the context of describing this invention, refer specifically a best mode for one or more embodiments for one or more applications of this invention. Such best modes are non-limiting, and may not be the best mode for all embodiments, applications, or implementation technologies, as one trained in the art will appreciate.

All examples are sample embodiments. In particular, the phrase “invention” should be interpreted under all conditions to mean, “an embodiment of this invention.” Examples, scenarios, and drawings are non-limiting. The only limitations of this invention are in the claims. May, Could, Option, Mode, Alternative and Feature—Use of the words, “may,” “could,” “option,” “optional,” “mode,” “alternative,” “typical,” “ideal,” and “feature,” when used in the context of describing this invention, refer specifically to various embodiments of this invention. Described benefits refer only to those embodiments that provide that benefit. All descriptions herein are non-limiting, as one trained in the art appreciates.

Embodiments of this invention explicitly include all combinations and sub-combinations of all features, elements and limitation of all claims. Embodiments of this invention explicitly include all combinations and sub-combinations of all features, elements, examples, embodiments, tables, values, ranges, and drawings in the specification and drawings. Embodiments of this invention explicitly include devices and systems to implement any combination of all methods described in the claims, specification and drawings. Embodiments of the methods of invention explicitly include all combinations of dependent method claim steps, in any functional order. Embodiments of the methods of invention explicitly include, when referencing any device claim, a substation thereof to any and all other device claims, including all combinations of elements in device claims. Claims for devices and systems may be restricted to perform only the methods of embodiments or claims.

We claim:

1. A method for reading a plurality of RFID transponders comprising the steps:
(i) transmitting an RF broadcast signal simultaneously from a predetermined grid of n transceivers;
(ii) receiving by at least one transceiver an at least one individual RF reply signal from at least one of a plurality of transponders wherein each of the n transceivers receives independently;
wherein individual reply signals from each of the transponders are in response to the RF broadcast signal.

2. The method of claim 1 wherein:
at least two individual reply signals are received simultaneously by at least two of the n transceivers from at least two of the transponders.

3. The method of claim 1 wherein:
the transmitting a request signal uses a fixed, predetermined transmit power from each of the n transceivers.

4. The method of claim 1 wherein:
at least a first portion of the n transceivers is arranged in a planer grid.

5. The method of claim 1 wherein:
a first portion of then transceivers is arranged in a planer grid; wherein the antenna coil of each transceiver in the first portion is oriented such that a strongest RF field is directed normal to the plane of the planer grid; and
wherein a second portion of the n transceivers such that the antenna coil of each transceiver in the second portion is oriented orthogonal to the antenna coils in the transceivers in the first portion.

6. The method of claim 1 wherein:
the transmitting a request signal is at a fixed, predetermined transmit power and is phase synchronous at each of the n transceivers.

7. The method of claim 1 wherein:
each of the n transceivers is permanently, operatively electrically connected to a controller.

8. The method of claim 1 wherein:
the individual reply signals are independent in time, and the reply signals from each of the transponders are unique from the other transponders.

9. The method of claim 1 wherein:
the individual reply signal protocols may be a mix of full duplex (FDX) and half duplex (HDX).

10. The method of claim 1 wherein:
the spacing of at least two adjacent transceivers in the grid of n transceivers is at least a spacing distance such that, for a first transponder in the plurality of transponders at a preselected target distance from a first transceiver of the two adjacent transceivers, the first transceiver receives a valid reply signal from the first transponder.

11. The method of claim 10 wherein:
the first transceiver receives the valid reply signal from the first RFID transponder at least a predetermined receive percentage of time when the first RFID transponder is at or closer than the target distance.
